(19) United States
(12) Patent Application Publication
(10) Pub. No.: US 2014/0011674 A1
(43) Pub. Date: Jan. 9, 2014

(54) PROCESS OF PRODUCING A TITANIUM DIOXIDE-BASED PHOTOCATALYST USED FOR DEGRADATION OF ORGANIC POLLUTANTS

(71) Applicant: NATIONAL CHI NAN UNIVERSITY, Puli (TW)

(72) Inventors: Yung-Pin TSAI, Puli Township (TW); Ruey-An DOONG, Puli (TW); Jhih-Ci YANG, Miaoli City (TW); Chih-Yu CHANG, Puli (TW)

(73) Assignee: NATIONAL CHI NAN UNIVERSITY, Puli (TW)

(21) Appl. No.: 13/739,239

(22) Filed: Jan. 11, 2013

(30) Foreign Application Priority Data
Jul. 9, 2012 (TW) 101124621

(51) Int. Cl. B01J 23/89

(52) U.S. Cl. CPC B01J 23/8926; B01J 23/8906
USPC 502/330; 502/347; 502/345

(57) ABSTRACT

A process of producing a titanium dioxide-based photocatalyst used for degradation of organic pollutants includes the steps of: (a) preparing a mixture solution which includes a titanium dioxide precursor and a transition metal salt having a transition metal ion which is capable of reducing a band gap of titanium dioxide; (b) aging the mixture solution so as to obtain a gel; (c) treating the gel to form an ion-doped titanium dioxide; (d) depositing silver nanoparticles on the ion-doped titanium dioxide to obtain a modified titanium dioxide-based photocatalyst; and (e) calcining the modified titanium dioxide-based photocatalyst.

### CROSS-REFERENCE TO RELATED APPLICATION

This application claims priority of Taiwanese application no. 101124621, filed on Jul. 9, 2012.

### BACKGROUND OF THE INVENTION

1. Field of the Invention

This invention relates to a process of producing a titanium dioxide-based photocatalyst, more particularly to a process of producing a titanium dioxide-based photocatalyst used for degradation of organic pollutants.

2. Description of the Related Art

It is well-known in the art that titanium dioxide functions as a photocatalyst and can be used to degrade/decompose organic pollutants. Because the band gap of titanium dioxide is about 3.2 eV, titanium dioxide has better degradation effect under radiation of UV light. However, the UV light makes up only about 5% of the total solar spectrum reaching the Earth's surface. Therefore, much effort has been devoted to developing a modified titanium dioxide-based photocatalyst which has a smaller band gap so as to utilize a broader spectrum of solar radiation, such as that shown in, for example, Taiwanese patent no. 1353964, U.S. Pat. No. 8,241,604, Taiwanese patent publication no. 200742614, etc. However, the efficiency of conventional titanium dioxide-based photocatalyst in degrading organic pollutants is still unsatisfactory.

### SUMMARY OF THE INVENTION

Therefore, an object of the present invention is to provide a process of producing a titanium dioxide-based photocatalyst used for degradation of organic pollutants. It is found that the titanium dioxide-based photocatalyst of this invention, which is doped with a transition metal ion and which has silver nanoparticles deposited thereon, can be used for degradation of organic pollutants, especially methylene blue, with an excellent degradation efficiency.

According to this invention, a process of producing a titanium dioxide-based photocatalyst used for degradation of organic pollutants includes the steps of:

(a) preparing a mixture solution which includes a titanium dioxide precursor and a transition metal salt having a transition metal ion which is capable of reducing a band gap of titanium dioxide;

(b) aging the mixture solution so as to obtain a gel;

(c) treating the gel to form an ion-doped titanium dioxide in which the titanium dioxide is derived from the titanium dioxide precursor and is doped by the metal ion, and which has a band gap lower than that of a titanium dioxide;

(d) depositing silver nanoparticles on the ion-doped titanium dioxide to obtain a modified titanium dioxide-based photocatalyst; and

(e) calcining the modified titanium dioxide-based photocatalyst.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flow chart showing a preferred embodiment of a process of producing a titanium dioxide-based photocatalyst used for degradation of organic pollutants according to the present invention;

FIG. 2 shows TEM images of titanium dioxide-based photocatalysts of Examples A1 to A3, which were made according to the process of the present invention;

FIG. 3 shows EDS analysis results of Examples A1 to A3;

FIG. 4a shows XRD results of titanium dioxide-based photocatalysts of Examples B1 to B3, which were made according to the process of the present invention;

FIG. 4b shows XRD results of titanium dioxide-based photocatalysts of Examples C1 to C3, which were made according to the process of the present invention;

FIG. 5 is a bar graph showing the effect of the addition of ion-doped titanium dioxide particles of Comparative Examples D1 to D5 on the degradation of methylene blue (MB);

FIG. 6 is a bar graph showing the effect of the addition of ion-doped titanium dioxide particles of Comparative Examples E1 to E5 on the degradation of MB;

FIG. 7 shows UV-Vis absorbance spectra of Examples B1 to B3 and Comparative Examples P1 and P2;

FIG. 8 shows UV-Vis absorbance spectra of Examples C1 to C3 and Comparative Examples P1 and P2;

FIG. 9 shows the variations in MB residue ratio after

MB solutions were respectively treated by Examples B1 and C1 and Comparative Examples D5 and E5 in a no-light environment;

FIG. 10 shows the variations in MB residue ratio after MB solutions were respectively treated by Comparative Examples P2 to P4 in a no-light environment;

FIG. 11 shows the variations in MB residue ratio after MB solutions were respectively treated by Examples B1 and C1 under radiation of a visible light (430 nm);

FIG. 12 shows the variations in TOC residue ratio after the MB solutions were respectively treated by Examples B1 and C1 under radiation of the visible light (430 nm);

FIG. 13 shows the variations in MB residue ratio after MB solutions were respectively treated by Examples B1 and C1 under radiation of a blue light;

FIG. 14 shows the variations in TOC residue ratio after the MB solutions were respectively treated by Examples B1 and C1 under radiation of the blue light;

FIG. 15 shows the variations in MB residue ratio after MB solutions were respectively treated by Examples B1 and C1 under radiation of a yellow light;

FIG. 16 shows the variations in TOC residue ratio after the MB solutions were respectively treated by Examples B1 and C1 under radiation of the yellow light; and

FIG. 17 is a schematic view of a testing system for evaluating the degradation of MB.

### DETAILED DESCRIPTION OF THE PREFERRED EMBODIMENTS

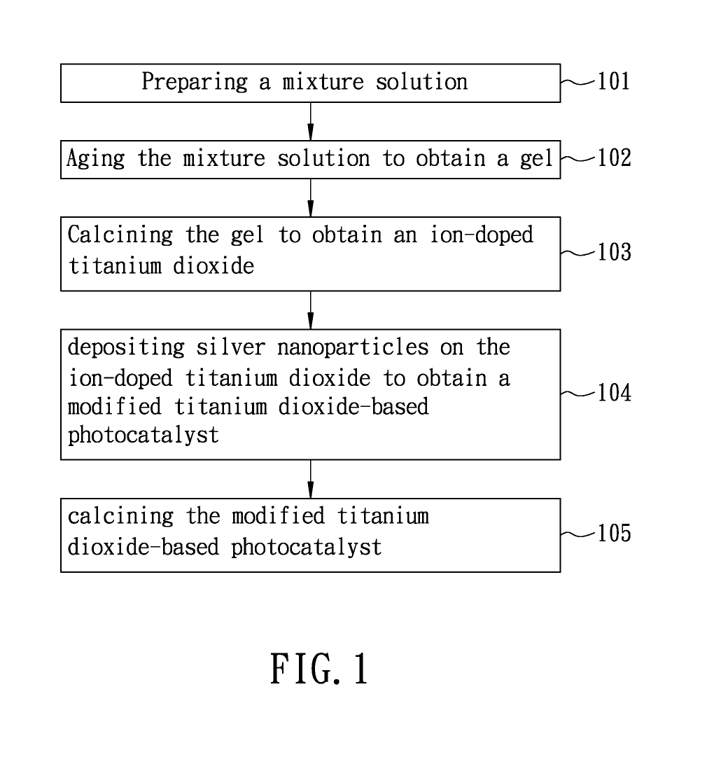

Referring to FIG. 1, the preferred embodiment of a process of producing a titanium dioxide-based photocatalyst used for degradation of organic pollutants according to the present invention includes the following steps 101 to 105.

In step 101, a mixture solution is prepared in a hermetic system controlled at a temperature of about 30° C. The mixture solution is prepared by mixing ethanol absolute with deionized water, adding poly(ethylene glycol)-block-poly(propylene) glycol-block-poly(ethylene glycol) thereto to obtain a premixture, adding an aqueous solution of monoprotic acid, a titanium dioxide precursor and a transition metal salt to the premixture, followed by mixing for 60 minutes. The monoprotic acid may be hydrochloric acid, acetic acid, nitric acid, etc. In the preferred embodiment, hydrochloric acid is used. The titanium dioxide precursor may be titanium alkoxide or titanium tetrachloride (TiCl₄). The titanium alkoxide may be titanium (IV) isopropoxide, titanium tetraisopropoxide (TTIP), etc. In the preferred embodiment, titanium (IV) isopropoxide is used. The transition metal salt has a transition metal ion that is capable of reducing a band gap of titanium dioxide, and may be copper halide, copper nitrate, iron (III) nitrate, iron (III) sulfate (Fe₂(SO₄)₃), etc. In the preferred embodiment, CuBr₂ or Fe₂(SO₄)₃ is used.

In step 102, the mixture solution is aged by heating the same from 30° C. to 110° C. at a heating rate of 1° C./minute, and maintaining the same at 110° C. until a gel is obtained.

In step 103, the gel is subjected to a calcining process to form an ion-doped titanium dioxide with an anatase phase. In the ion-doped titanium dioxide, the titanium dioxide is derived from the titanium dioxide precursor and is doped by the metal ion, and the ion-doped titanium dioxide has a band gap lower than that of a titanium dioxide. The metal ion has a mole percent ranging from 0.01% to 1% based on the total mole number of titanium ions in the ion-doped titanium dioxide.

Preferably, the gel is calcined at a temperature ranging from 200° C. to 600° C., followed by grinding to thereby obtain a plurality of ion-doped titanium dioxide particles.

In step 104, silver nanoparticles are deposited on the ion-doped titanium dioxide so as to obtain a modified titanium dioxide-based photocatalyst. In detail, the ion-doped titanium dioxide is mixed with silver nitrate in an amide solution in a no-light environment, followed by heating (e.g., hydrothermal treatment) the same in the no-light environment to subject the silver nitrate to a redox reaction such that the silver nanoparticles are formed on the ion-doped titanium dioxide. In the preferred embodiment, the amide solution includes urea. The silver nanoparticles are preferably in an amount greater than 1 wt %, more preferably in an amount ranging from 1 wt % to 10 wt %, based on the total weight of the modified titanium dioxide-based photocatalyst.

In step 105, the modified titanium dioxide-based photocatalyst is calcined at a temperature ranging from 200° C. to 600° C., preferably ranging from 400° C. to 600° C. The modified titanium dioxide-based photocatalyst also has an anatase phase, which exhibits relatively strong photoactivity.

The present invention will now be explained in more detail below by way of the following examples.

### Example A1

Preparation of ion-doped titanium dioxide 14 ml of ethanol absolute (99.9%, Merck) was mixed with 1 ml of deionized water, followed by mixing with gram of poly(ethylene glycol)-block-poly(propylene)glycol-block-poly(ethylene glycol) (Aldrich) to obtain a premixture. 2.5 ml of hydrochloric acid (aqueous, 30-37%, Merck) and 3.574×10⁻² gram of CuBr₂ (95%, Katayama Chemical Industries Co., Ltd.) were mixed with the premixture, followed by mixing with 5 ml of titanium (IV) isopropoxide (97%, Aldrich) at 30° C. for 60 minutes to obtain a mixture solution. The mixture solution was heated up to 110° C. using an oil bath (silicon oil) at a heating rate of 1° C/min, and then maintained at 110° C. until a gel was obtained. Thereafter, the gel was introduced to a high temperature furnace and calcined at 400° C. for 4 hours, followed by grinding to obtain a plurality of ion-doped titanium dioxide particles. In Example A1, CuBr₂ was included in the mixture solution such that copper ion has a mole percent of 1% based on the total mole number of titanium ions in the ion-doped titanium dioxide particles.

Preparation of Titanium Dioxide-Based Photocatalyst

1 gram of ion-doped titanium dioxide particles was mixed with 100 ml of an urea aqueous solution which has silver nitride (AgNO₃, 95%, Katayama Chemical Industries Co., Ltd.) in a concentration of 1.03×10⁻² M and which has an urea concentration of 0.42 M., followed by heating at 80° C. for 4 hours, and centrifugation to remove the residual aqueous phase. The solid phase part was washed 4 times with deionized water, vacuum dried at 100° C. for 2 hours, introduced to a high temperature furnace in which the temperature was raised to 400° C. at a rate of 2° C./min, and calcined at 400° C. for 4 hours, thereby obtaining the titanium dioxide-based photocatalyst. Based on the concentration of silver nitride in the urea aqueous solution, the amount of the silver nanoparticles was speculated to be 10 wt % based on the total weight of the titanium dioxide-based photocatalyst. The titanium dioxide-based photocatalyst prepared in Example A1 was designated as Ag (10 wt %)/Cu (1%)-TiO₂.

### Example A2

Example A2 was prepared according to the procedure used for preparing Example A1 except that, in the urea aqueous solution, the concentration of silver nitride was 1.03×10⁻³ M (i.e., the amount of the silver nanoparticles was speculated to be 1 wt % based on the total weight of the titanium dioxide-based photocatalyst). The titanium dioxide-based photocatalyst prepared in Example A2 was designated as Ag (1 wt %)/Cu (1%)-TiO₂.

### Example A3

Example A3 was prepared according to the procedure used for preparing Example A1 except that, in the urea aqueous solution, the concentration of silver nitride was 1.03×10⁻⁴ M (i.e., the amount of the silver nanoparticles was speculated to be 0.1 wt % based on the total weight of the titanium dioxide-based photocatalyst). The titanium dioxide-based photocatalyst prepared in Example A3 was designated as Ag (0.1 wt %)/Cu (1%)-TiO₂.

[TEM and EDS Analysis]

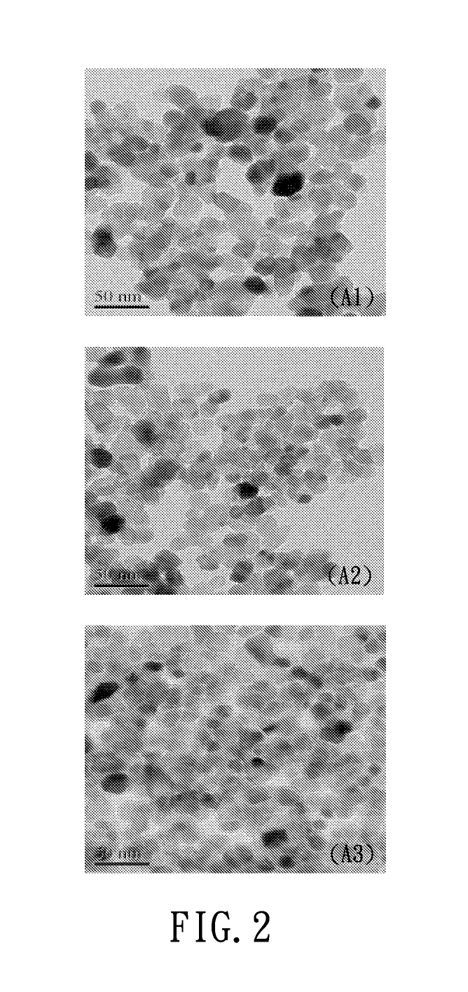

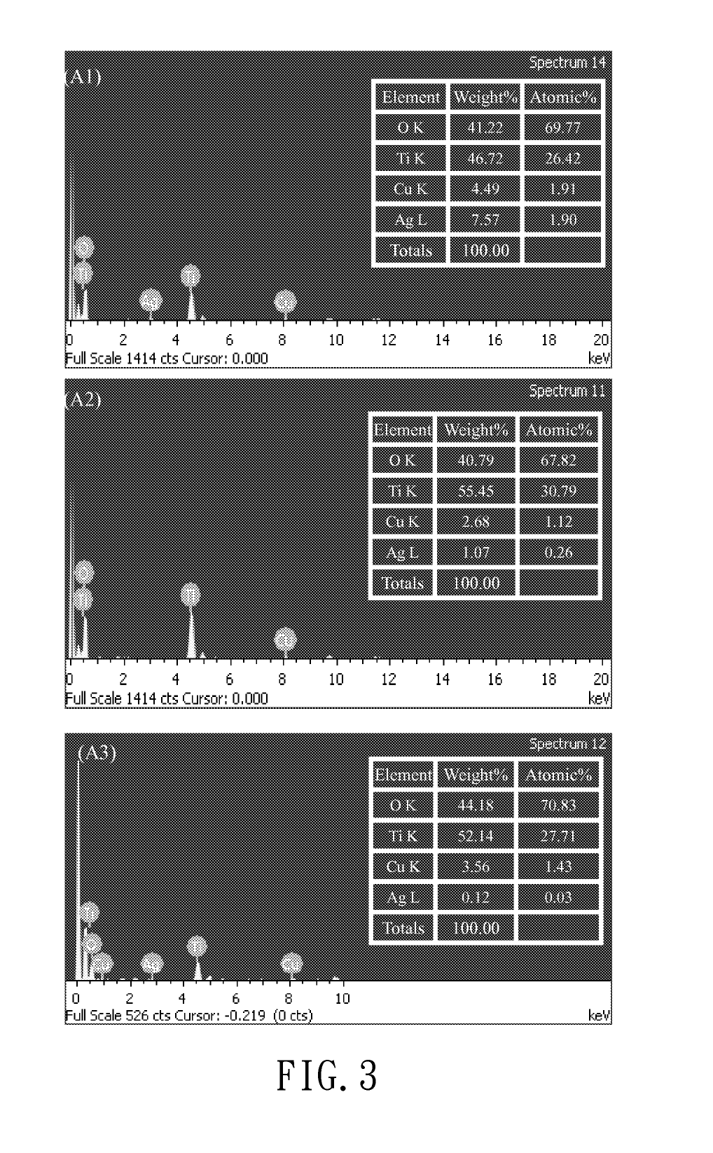

The titanium dioxide-based photocatalyst prepared in each of Examples A1 to A3 was analyzed by a transmission electron microscope (TEM; Joel JEM-2100F) and by an energy dispersive X-ray spectroscope (EDS; Joel JEM-2100F). The TEM results are shown in FIG. 2, and the EDS results are shown in FIG. 3.

From the TEM results shown in FIG. 2, it was found that the titanium dioxide-based photocatalyst of each of Examples A1 to A3 includes a plurality of round-shaped particles each having a diameter of about 20 nm to 30 nm. From the EDS results shown in FIG. 3, it was found that the titanium dioxide-based photocatalyst of each of Examples A1 to A3 includes four elements, i.e., titanium, oxygen, copper, and silver, thereby proving that the titanium dioxide-based photocatalyst made in each of Examples A1 to A3 includes two different metal elements, i.e., Cu and Ag.

### Example B1

Example B1 was prepared according to the procedure used for preparing Example A1 except that 3.57×10⁻⁴ gram of CuBr₂ was added for mixing with the premixture. The titanium dioxide-based photocatalyst prepared in Example B1 was designated as Ag (10 wt %)/Cu (0.01%)-TiO₂.

### Example B2

Example B2 was prepared according to the procedure used for preparing Example A2 except that 3.57×10⁻⁴ gram of CuBr₂ was added for mixing with the premixture. The titanium dioxide-based photocatalyst prepared in Example B2 was designated as Ag (1 wt %)/Cu (0.01%)-TiO₂.

### Example B3

Example B3 was prepared according to the procedure used for preparing Example A3 except that 3.57×10⁻⁴ gram of CuBr₂ was added for mixing with the premixture. The titanium dioxide-based photocatalyst prepared in Example B3 was designated as Ag (0.1 wt %)/Cu (0.01%)-TiO₂.

### Example C1

Example C1 was prepared according to the procedure used for preparing Example A1 except that, instead of CuBr₂, 3.2×10⁻⁴ gram of Fe₂(SO₄)₃ was added for mixing with the premixture. The titanium dioxide-based photocatalyst prepared in Example C1 was designated as Ag (10 wt %)/Fe (0.01%)-TiO₂.

### Example C2

Example C2 was prepared according to the procedure used for preparing Example A2 except that 3.2×10⁻⁴ gram of Fe₂(SO₄)₃ was added instead of CuBr₂ for mixing with the premixture. The titanium dioxide-based photocatalyst prepared in Example C1 was designated as Ag (1 wt %)/Fe (0.01%)-TiO₂.

### Example C3

Example C3 was prepared according to the procedure used for preparing Example A3 except that 3.2×10⁻⁴ gram of Fe₂(SO₄)₃ was added instead of CuBr₂ for mixing with the premixture. The titanium dioxide-based photocatalyst prepared in Example C1 was designated as Ag (0.1 wt %)/Fe (0.01%)-TiO₂.

[XRD Analysis]

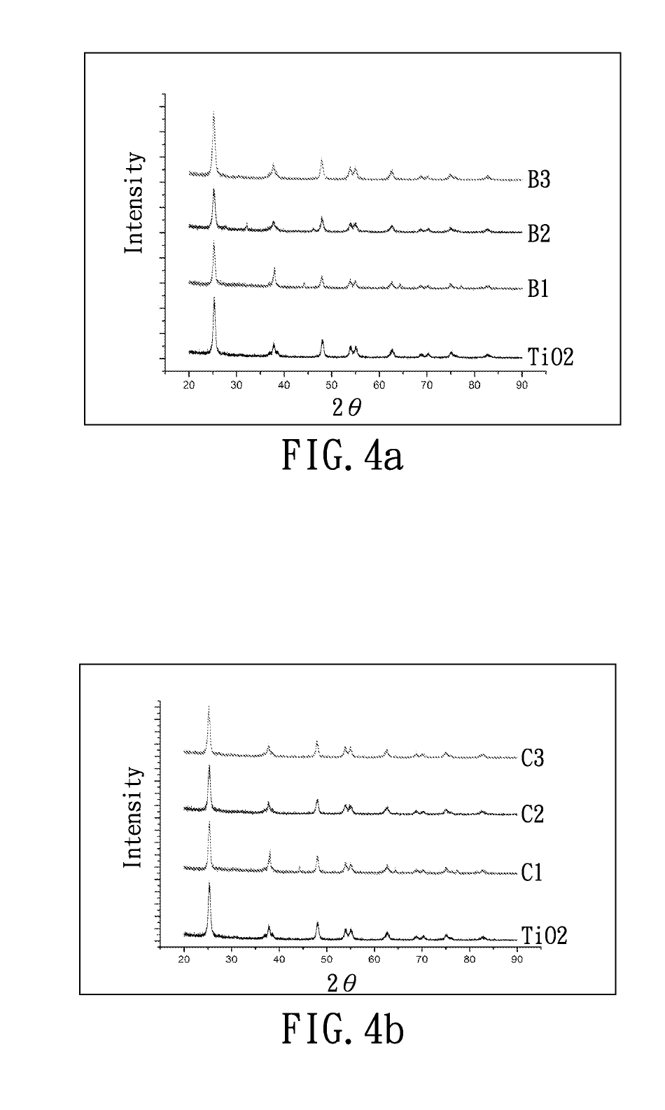

The titanium dioxide-based photocatalyst prepared in each of Examples B1 to B3 and C1 to C3 was analyzed using an X-ray diffractometer (XRD, TTRAX III, from Rigaku, Japan). The XRD results are shown in FIGS. 4a and 4b.

A standard spectrum of an anatase phase of titanium dioxide in the JCPDS database has characteristic peaks at 2θ of about 25.281, 37.899, 48.049, 53.890, and 55.060 (also shown in FIGS. 4a and 4b). From the XRD results shown in FIGS. 4a and 4b, each of Examples B1 to B3 and C1 to C3 also had the characteristic peaks of the anatase phase of titanium dioxide. It has thus proved that the titanium dioxide-based photocatalyst of each of Examples B1 to B3 and C1 to C3 mainly had an anatase phase which is more suitable for use as a photocatalyst than rutile and brookite phases.

Furthermore, the titanium dioxide-based photocatalyst of each of Examples B1 and C1 had a relatively large amount of silver nanoparticles (about 10 wt %). Characteristic peaks of Ag⁰ at 2θ (44.277, 64.426 and 77.472) can also be observed in Examples B1 and C1.

### Comparative Example D1

Comparative Example D1 was prepared according to the procedure used for preparing the ion-doped titanium dioxide particles in Example A1, and was designated as Cu (1%)-TiO₂.

### Comparative Examples D2 to D5

Each of Comparative Examples D2 to D5 was prepared according to the procedure used for preparing Comparative Example D1, except that the amounts of CuBr₂ in Comparative Examples D2 to D5 were different. The mole percents of copper ion in Comparative Examples D2 to D5 were 0.5%, 0.1%, 0.06%, and 0.01%, respectively, based on the total mole number of titanium ions in the ion-doped titanium dioxide particles. Comparative Examples D2 to D5 were designated as Cu (0.5%)-TiO₂, Cu (0.1%)-TiO₂, Cu (0.06%)-TiO₂, and Cu (0.01%)-TiO₂, respectively.

### Comparative Example E1

Comparative Example E1 was prepared according to the procedure used for preparing the ion-doped titanium dioxide particles in Example A1 except that, instead of CuBr₂, 3.2×10⁻² gram of Fe₂(SO₄)₃ was added for mixing with the premixture. Comparative Example E1 was designated as Fe (1%)-TiO₂.

### Comparative Examples E2 to E5

Each of Comparative Examples E2 to E5 was prepared according to the procedure used for preparing Comparative Example E1, except that the amounts of Fe₂(SO₄)₃ in Comparative Examples E2 to E5 were different. The mole percents of ferric ion in Comparative Examples E2 to E5 were 0.5%, 0.1%, 0.06%, and 0.01%, respectively, based on the total mole number of titanium ions in the ion-doped titanium dioxide particles. Comparative Examples E2 to E5 were designated as Fe (0.5%)-TiO₂, Fe (0.1%)-TiO₂, Fe (0.06%)-TiO₂, and Fe (0.01%)-TiO₂, respectively.

[First Photocatalytic Activity Test (Under Visible Light of 430 nm)]

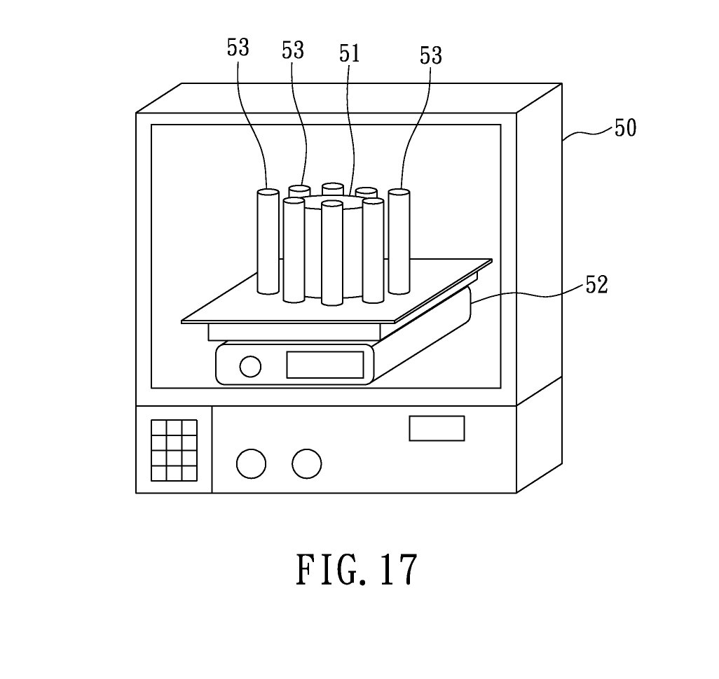

Comparative Example D1 was evaluated by the degradation of an azo dye (methylene blue, MB) using a testing system 50 shown in FIG. 17. For testing Comparative Example D1, 1 liter of MB solution (10 mg/L) was poured into a vessel 51, and 0.1 g of the ion-doped titanium dioxide particles of Comparative Example D1 was added thereto. Then, the ion-doped titanium dioxide particles in the vessel 51 were evenly dispersed in the MB solution using a magnetic stirrer 52 (650 rpm), the temperature in the testing system 50 was controlled at 25° C., and the vessel 51 was irradiated by visible light (430 nm) for 18 hours. The visible light was emitted from a plurality of lamps 53 that were disposed to surround the vessel 51. After the testing, the solution inside the vessel 51 was sampled, and filtered using a 0.45 μm syringe filter to obtain a tested solution. A UV-VIS spectrometer was used to measure an absorption value of the tested solution at λ=665 nm, for calculating a residue concentration of MB in the tested solution so ad to calculate a MB degradation ratio.

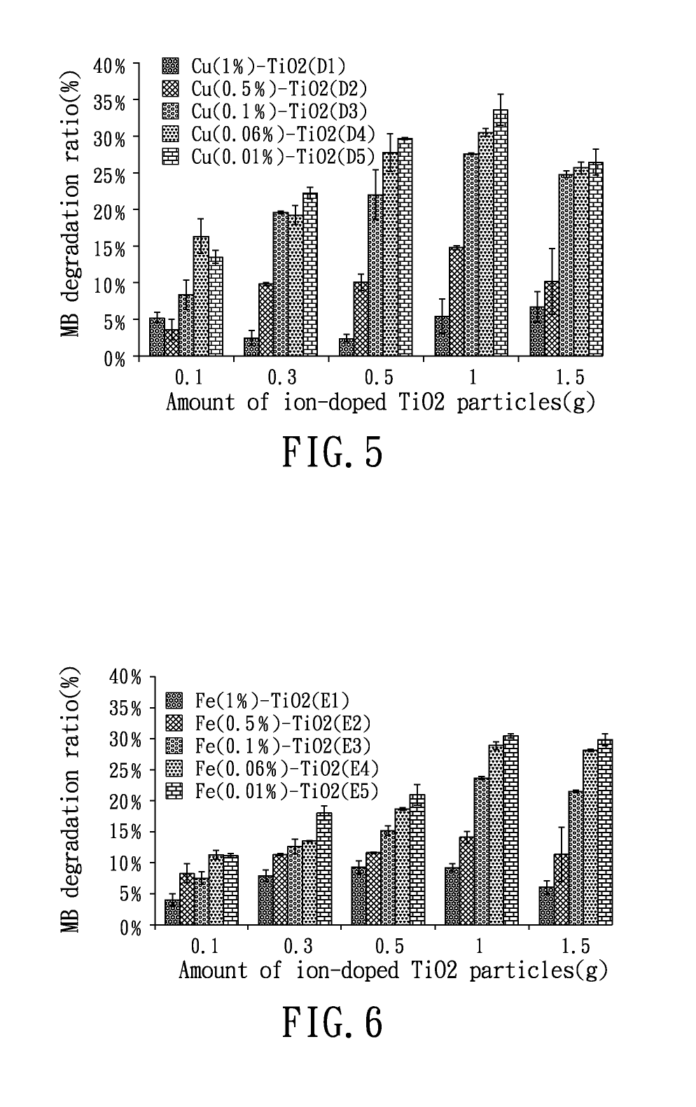

MB degradation ratio=(C₀−Cₜ/C₀×100% (I)

where C₀ is an initial concentration of MB and Cₜ is a residue concentration of MB. The results are shown in FIG. 5.

In addition, Comparative Example D1 was further evaluated by varying the amounts of the ion-doped titanium dioxide particles (i.e., 0.3 g, 0.5 g, 1 g, and 1.5 g) for dispersion in the MB solution, and the results are also shown in FIG. 5.

A blank experiment was also performed. In the blank experiment, 1 liter of MB solution (10 mg/L), without addition of the ion-doped titanium dioxide particles, was irradiated by visible light (430 nm) for 18 hours, and it is noted that the concentration of MB solution was substantially not reduced.

Comparative Examples D2 to D5 and E1 to E5 were also evaluated according to the procedure for evaluating Comparative Example D1. FIGS. 5 and 6 show the results.

From the results shown in FIGS. 5 and 6, it can be noted that 1 gram of the ion-doped titanium dioxide particles was preferably added for degradation of one liter of MB solution (10 mg/L), and the mole percent of copper ion (or ferric ion) was preferably 0.01% based on the total mole number of titanium ions in the ion-doped titanium dioxide particles.

### Comparative Example P1

Comparative Example P1 was prepared according to the procedure used for preparing the ion-doped titanium dioxide particles in Example A1, except that CuBr₂ was not added. That is, Comparative Example P1 was pure titanium dioxide particles, and was designated as TiO₂.

### Comparative Example P2

Comparative Example P2 was prepared according to the procedure used for preparing the titanium dioxide-based photocatalyst of Example A1, except that CuBr₂ was not added. The titanium dioxide-based photocatalyst of Comparative Example P2 was designated as Ag (10 wt %)/TiO₂.

[UV/VIS Absorption]

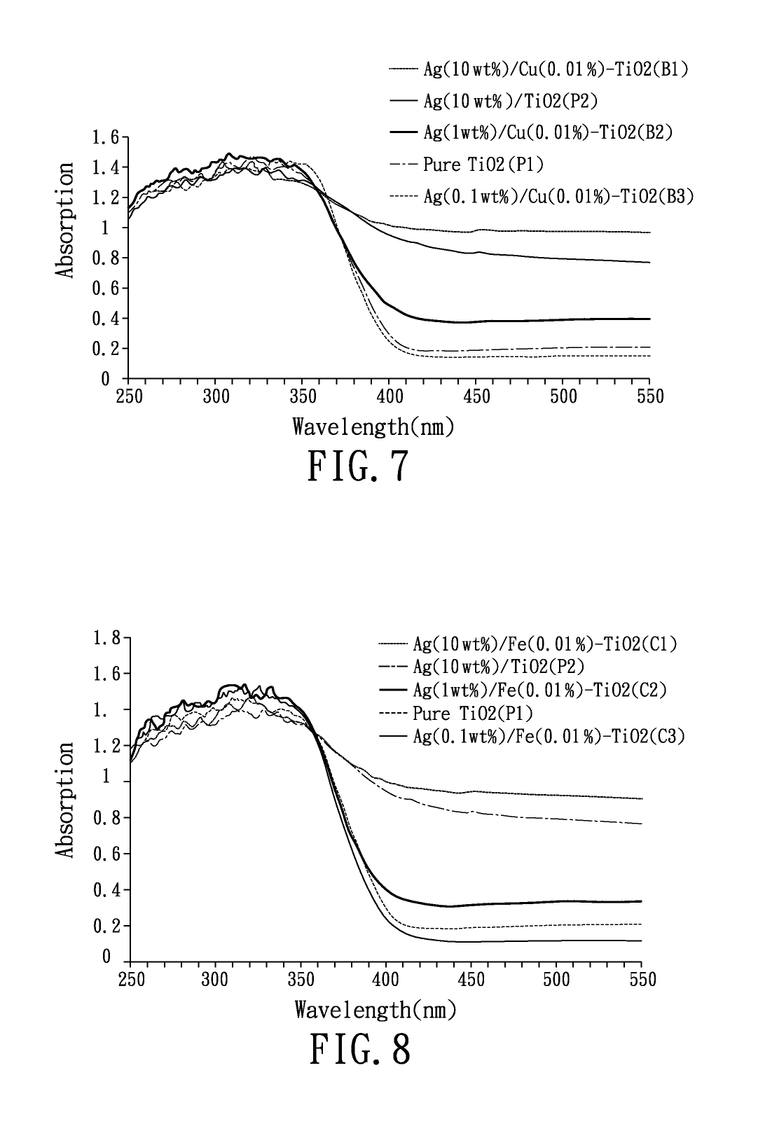

Examples B1 to B3 and C1 to C3 and Comparative Examples P1 and P2 were analyzed using a UV-VIS spectrometer (UV-1601, JEOL) . The spectrometer recorded a scan of the UV-Vis absorbance spectrum from 250 nm to 550 nm and the results are shown in FIGS. 7 and 8.

From the results shown in FIGS. 7 and 8, it can be found that the absorbance of visible light increased with an increase in the amount of the silver nanoparticles, and it can be speculated that the band gap of the titanium dioxide was considerably reduced by deposition of the silver nanoparticles in an amount greater than 1 wt % based on the total weight of the titanium dioxide-based photocatalyst.

### Comparative Example P3

Comparative Example P3 was prepared according to the procedure used for preparing Comparative Example P2, except that the concentration of silver nitride in the urea aqueous solution was 1.03×10⁻³M (i.e., the amount of the silver nanoparticles was speculated to be 1 wt % based on the total weight of the titanium dioxide-based photocatalyst). The titanium dioxide-based photo-catalyst prepared in Comparative Example P3 was designated as Ag (1 wt %)/TiO₂.

### Comparative Example P4

Comparative Example P4 was prepared according to the procedure used for preparing Comparative Example P2, except that the concentration of silver nitride in the urea aqueous solution was 1.03×10⁻⁴M (i.e., the amount of the silver nanoparticles was speculated to be 0.1 wt % based on the total weight of the titanium dioxide-based photocatalyst). The titanium dioxide-based photo-catalyst prepared in Comparative Example P4 was designated as Ag (0.1 wt %)/TiO₂.

[Adsorption Test]

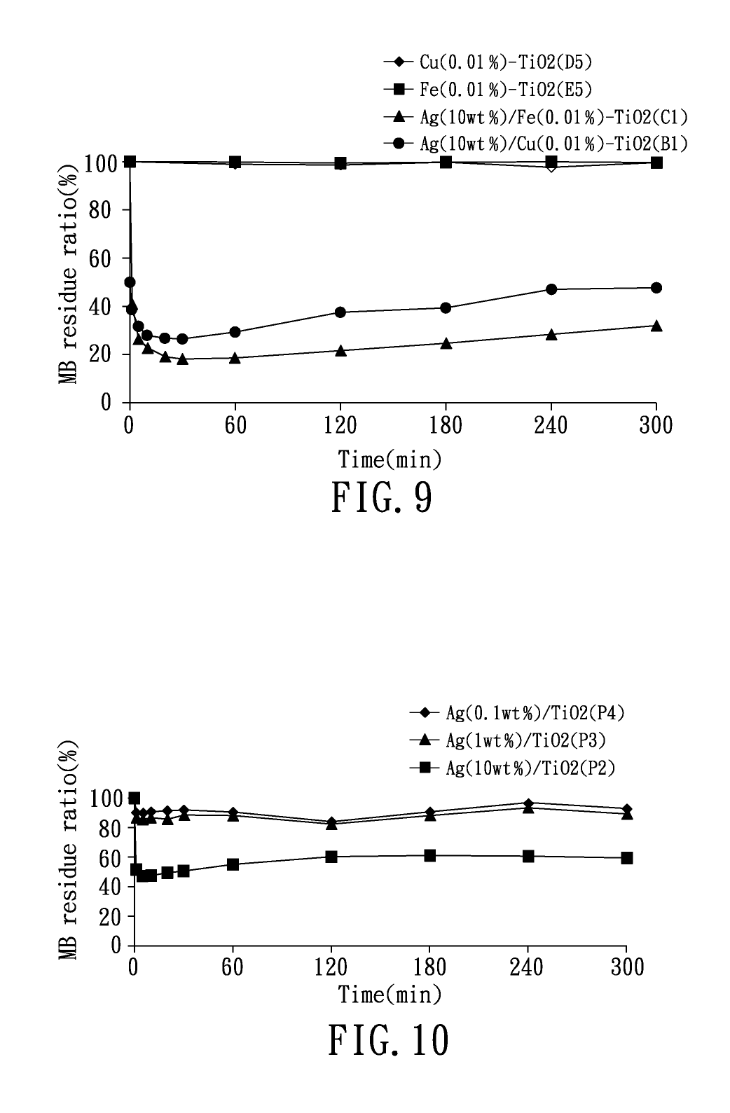

Example B1 was evaluated by an adsorption test, in which the temperature was controlled at 25° C., and 1 gram of the titanium dioxide-based photocatalyst of Example B1 was evenly dispersed in 1 liter of an MB solution (10 mg/L) using a magnetic stirrer (650 rpm) in a no-light environment. The MB solution was sampled at predetermined time invervals. The sampled solution was filtered using a 0.45 μm syringe filter to obtain a tested solution for calculating a concentration of MB in the tested solution. The MB residue ratio is equal to Cₜ/C₀×100%, where C₀ is an initial concentration of MB and Cₜ is a residue concentration of MB. The results are shown in FIG. 9.

Example C1 and Comparative Examples D5, E5, and P2 to P4 were also evaluated according to the procedure for evaluating Example B1. FIGS. 9 and 10 show the results.

It should be noted that because this test was performed in a no-light environment, the MB was assumed not to have reacted with the photocatalyst but might have been adsorbed by the photocatalyst. From the results shown in FIG. 9, it is noted that each of comparative Examples D5 and E5, which did not include silver nanoparticles, had an MB residue ratio close to 100%. However, when the photocatalyst was deposited with the silver nanoparticles (Examples B1 and C1), the MB residue ratio was greatly reduced. Referring to FIG. 10, when the photocatalyst was deposited with the silver nanoparticles in an amount not greater than 1 wt % (Comparative Examples P3 and P4), the MB residue ratio was relatively high. When the photocatalyst was deposited with the silver nanoparticles in an amount of 10 wt % (Comparative Example P2), the MB residue ratio was greatly reduced. From this test, it can be speculated that the photocatalyst deposited with silver nanoparticles has a better adsorption ability for MB, and can thus facilitate the degradation of organic pollutants (such as MB).

[Second Photocatalytic Activity Test (Under Visible Light of 430 nm)]

Examples B1 and C1 were evaluated according to the procedure of the previous adsorption test, except that the MB solution was irradiated by visible light of 430 nm in this test. The MB solution was sampled at predetermined time intervals for analyzing an MB residue ratio and a total organic carbon (TOC) residue ratio after removal of the photocatalyst. The TOC was measured using a TOC analyzer (Phoenix 8000, Tekmar-Dohrmann).

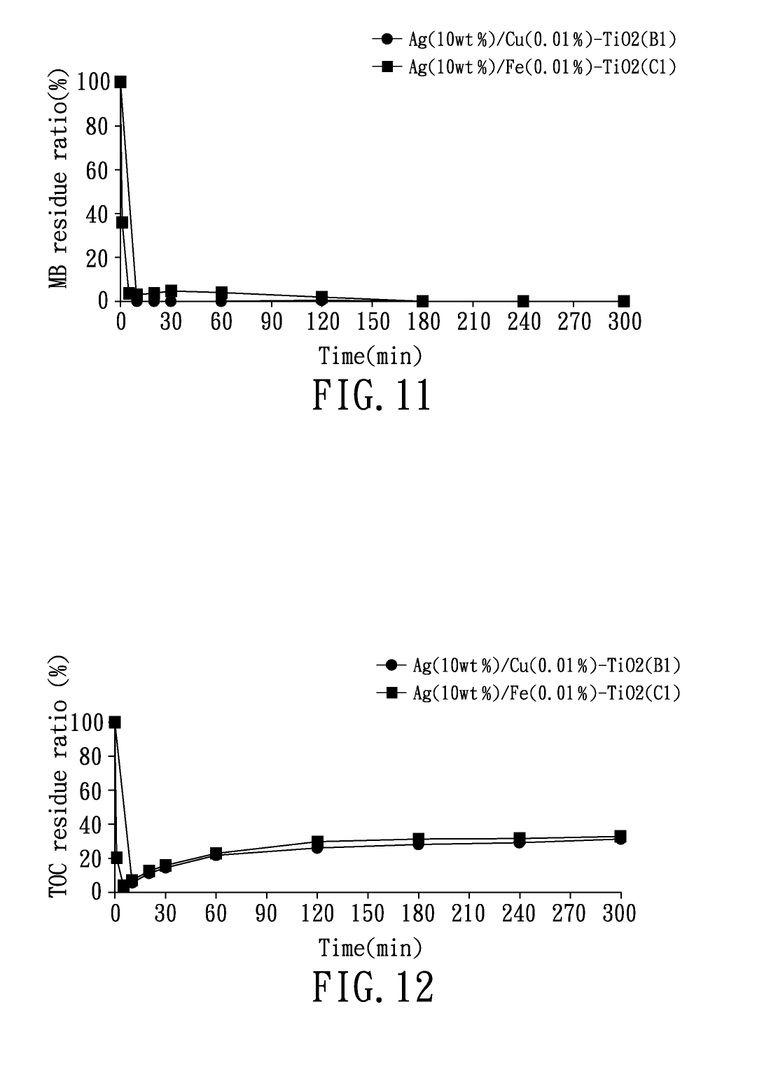

TOC residue ratio=TOCₜ/TOC₀×100% (II)

where TOC₀ is an initial TOC value of the MB solution and Tacₜ is a TOC value of the MB solution after a period of time. The results are shown in FIGS. 11 and 12.

From the result shown in FIG. 11, it is noted that the MB treated by Example B1 was completely degraded after 10 minutes, and that the MB treated by C1 was completely degraded after 180 nm. From the result shown in FIG. 12, it is noted that the MB was not completely decomposed into carbon dioxide, and it is speculated that the degraded pollutants derived from the MB were adsorbed by the photocatalyst of Example B1 or C1 and were then released to the solution being analyzed with the passing of time.

[Third Photocatalytic Activity Test (Under Blue Light of 460˜465 nm)]

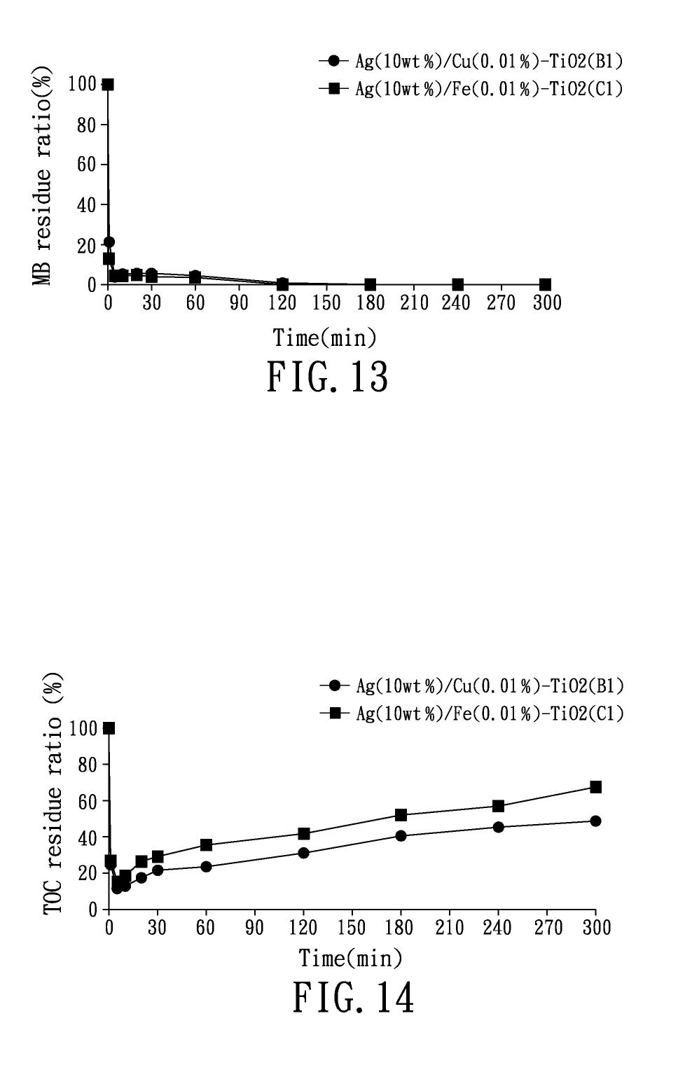

Examples B1 and C1 were evaluated according to the procedure of the second photocatalytic activity test, except that the MB solution was irradiated by blue light of 460˜465 nm in this test. The results are shown in FIGS. 13 and 14.

Based on the prior art disclosure (see Wan-jiun Chen, “Characterization and Photooxidation of N-doped Photocatalyst Prepared by Thermal Deposition,” Master's Thesis, 2008, National Taiwan University of Science and Technology, Department of Chemical Engineering), MB treated by a conventional nitrogen-doped titanium dioxide had a degradation ratio of 68% when being irradiated by blue light. From the result shown in FIG. 13, it is noted that the MB treated by Example B1 or C1 was completely degraded after being treated for 180 minutes. Thus, in comparison with conventional photocatalysts, the photocatalysts made according to the process of this invention (Examples B1 and C1) are more active under blue light irradiation.

From the result shown in FIG. 14, it is noted that the MB was not completely decomposed into carbon dioxide, and it is speculated that the degraded pollutants derived from the MB were adsorbed by the photocatalyst of Example B1 or C1 and then were released to the solution being analyzed with the passing of time.

[Fourth Photocatalytic Activity Test (Under Yellow Light of 588˜593 nm)]

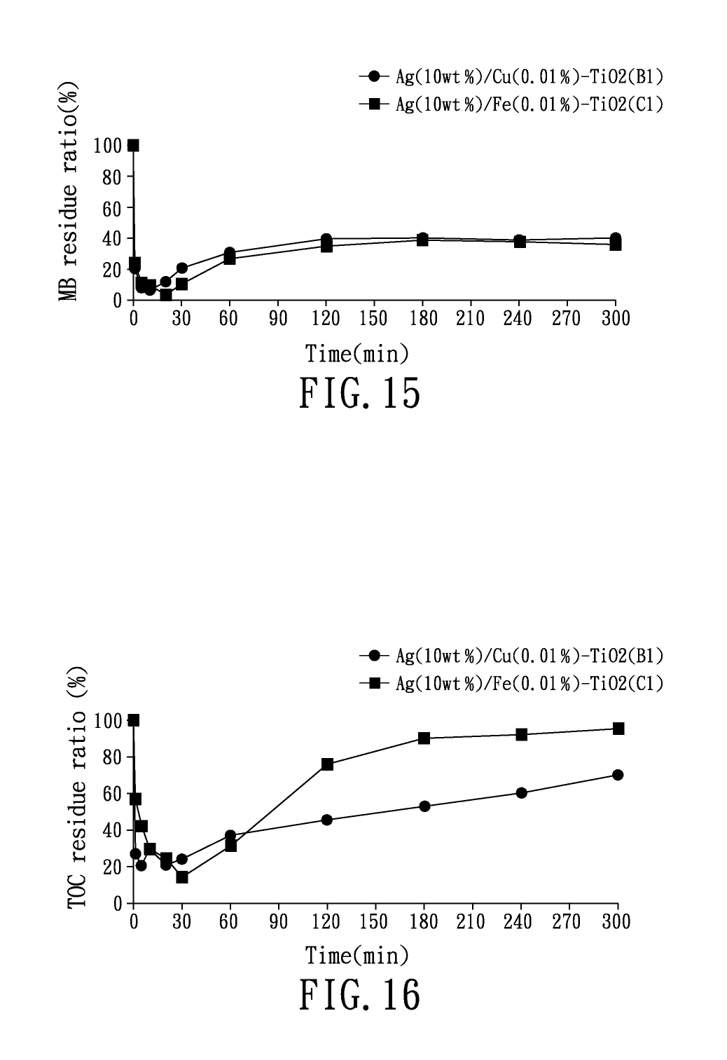

Examples B1 and C1 were evaluated according to the procedure of the second photocatalytic activity test, except that the MB solution was irradiated by yellow light of 588˜593 nm in this test. The results are shown in FIGS. 15 and 16.

From the result shown in FIG. 15, it is noted that 40˜42% of the MB was not degraded after the MB solution was treated by Example B1 or C1 for 300 minutes. This indicates that 58˜60% of the MB was degraded in this test. From the result shown in FIG. 16, it is noted that the

MB was not completely decomposed into carbon dioxide. It has thus been shown that the photocatalyst made according to the process of this invention has a relatively high MB residue ratio and a relatively high TOC residue ratio when being irradiated by yellow light that provides relatively low energy.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A process of producing a titanium dioxide-based photocatalyst used for degradation of organic pollutants, comprising the steps of:
(a) preparing a mixture solution which includes a titanium dioxide precursor and a transition metal salt having a transition metal ion which is capable of reducing a band gap of titanium dioxide;
(b) aging the mixture solution so as to obtain a gel;
(c) treating the gel to form an ion-doped titanium dioxide in which the titanium dioxide is derived from the titanium dioxide precursor and is doped by the metal ion, and which has a band gap lower than that of a titanium dioxide;
(d) depositing silver nanoparticles on the ion-doped titanium dioxide to obtain a modified titanium dioxide-based photocatalyst; and
(e) calcining the modified titanium dioxide-based photocatalyst.

2. The process of claim 1, wherein, in step (c), the gel is subjected to a calcining process such that the ion-doped titanium dioxide has an anatase phase.

3. The process of claim 1, wherein the transition metal salt is selected from the group consisting of copper halide, copper nitrate, iron (III) nitrate, and iron (III) sulfate.

4. The process of claim 1, wherein step (d) is implemented by mixing the ion-doped titanium dioxide with silver nitrate in an amide solution, and subjecting the silver nitrate to a redox reaction such that the silver nanoparticles are formed on the ion-doped titanium dioxide.

5. The process of claim 4, wherein the redox reaction is initiated by heating.

6. The process of claim 4, step (d) is carried out in a no-light environment.

7. The process of claim 1, wherein the titanium dioxide precursor is selected from the group consisting of titanium alkoxide and titanium tetrachloride.

8. The process of claim 1, wherein, in step (e), the calcining is performed at a temperature ranging from 200° C. to 600° C.

9. The process of claim 1, wherein the metal ion has a mole percent ranging from 0.01% to 1% based on the total mole number of titanium ions in the ion-doped titanium dioxide.

10. The process of claim 9, wherein the silver nanoparticles are in an amount greater than 1 wt % based on the total weight of the modified titanium dioxide-based photocatalyst.

11. The process of claim 1, wherein the silver nanoparticles are in an amount ranging from 1 wt % to 10 wt % based on the total weight of the modified titanium dioxide-based photocatalyst.
